(19) United States
(12) Patent Application Publication
(10) Pub. No.: US 2004/0129810 A1
(43) Pub. Date: Jul. 8, 2004

(54) Trash compactor with shredder

(76) Inventors: Andrew Kasprowicz, Fort Smith, AR (US); Devin Keith Cochran, Spiro, OK (US); Earl Warren Mann, Greenwood, AR (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/338,652

(22) Filed: Jan. 8, 2003

(51) Int. Cl. B02C 19/00

(52) U.S. Cl. 241/101.2

(57) ABSTRACT

A compactor that has a built-in shredder. The compactor has a receptacle with a receptacle opening at a top of the receptacle for receiving refuse. A shredder has a receiving opening accessible from an outside of the compactor and a discharge opening located at a position higher than the receptacle opening for delivering shredded items into the receptacle. A ram vertically compacts refuse and the shredded items toward a bottom portion of the receptacle.

### BACKGROUND OF THE INVENTION

The present invention relates to trash compactors and more particularly to trash compactors with built-in shredders.

A user typically delivers trash into a conventional trash compactor by opening an access door of the compactor and depositing the trash into a receptacle, which is located behind the access door. The trash compactor has a ram, which is driven into the receptacle to compact the trash within the receptacle.

When shredding items, such as paper documents, the user uses a typical stand-alone shredding machine. The shredding machine dispenses shredded items into a shredding machine receptacle or a trash receptacle. If the user wants to compact the shredded items, the user then empties the contents of the shredding machine receptacle into the trash compactor receptacle. This process of transferring shredded items from the shredding machine to the trash compactor can be time consuming when shredding a large number of documents, and can also be messy when the shredded items fall to the ground instead of into the trash compactor receptacle.

Based on the above-described problems of trash compactors and stand-alone shredding machines, it is therefore desirable to improve them.

### SUMMARY OF THE INVENTION

A trash compactor consistent with the present invention has a built-in shredder. The shredder, which is an integral part of the trash compactor, has a receiving opening for receiving items to be shredded and a discharge opening. The receiving opening is accessible from an outside of the compactor and the discharge opening is located at a position higher than the trash compactor's receptacle for delivering shredded items into the receptacle. The trash compactor also has a ram for compacting items in the receptacle.

Therefore, the trash compactor is multifunctional in that it provides functionality for compaction as well as shredding. By combining the shredder into the trash compactor, the user saves time when shredding by not having to transfer shredded items to the trash compactor for compaction. Also, space is conserved, since the user has one trash compactor that performs both compacting and shredding.

In accordance with apparatuses consistent with the present invention, a compactor is provided. The compactor comprises a receptacle having a receptacle opening at a top of the receptacle for receiving refuse, a shredder having a receiving opening accessible from an outside of the compactor and a discharge opening located at a position higher than the receptacle opening for delivering shredded items into the receptacle, and a ram for vertically compacting refuse and the shredded items toward a bottom portion of the receptacle.

In an embodiment, the compactor has a door for permitting access to the receptacle, wherein the receiving opening of the shredder can be disposed within an opening of the door. The user can therefore empty the receptacle by opening the door and removing the receptacle without interfering with the shredder. Also, in an embodiment, a removable bag can be placed within the receptacle such that items are compacted into the bag. The compactor can then be emptied by removing the bag from the receptacle.

A level sensing device can determine the level of items within the receptacle. As a safety feature, a sensor can determine when the door is in a closed position, wherein the shredder and the ram do not operate when the door is not in the closed position.

The above-mentioned and other features, utilities, and advantages of the invention will become apparent from the following detailed description of the preferred embodiments of the invention together with the accompanying drawings.

Other devices, methods, features, and advantages of the invention will become apparent to one with skill in the art upon examination of the following figures and detailed description. It is intended that all such additional devices, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a block diagram of a compactor consistent with the present invention;

FIG. 2 depicts a perspective view of a compactor consistent with the present invention;

FIG. 3 depicts the compactor of FIG. 2 with the door partially opened; and

FIG. 4 depicts a side sectional view of the compactor of FIG. 2.

### DETAILED DESCRIPTION OF THE PREFERRED EMBODIMENTS

Reference will now be made in detail to an implementation consistent with the present invention as illustrated in the accompanying drawings. Wherever possible, the same reference numbers will be used throughout the drawings and the following description to refer to the same or like parts.

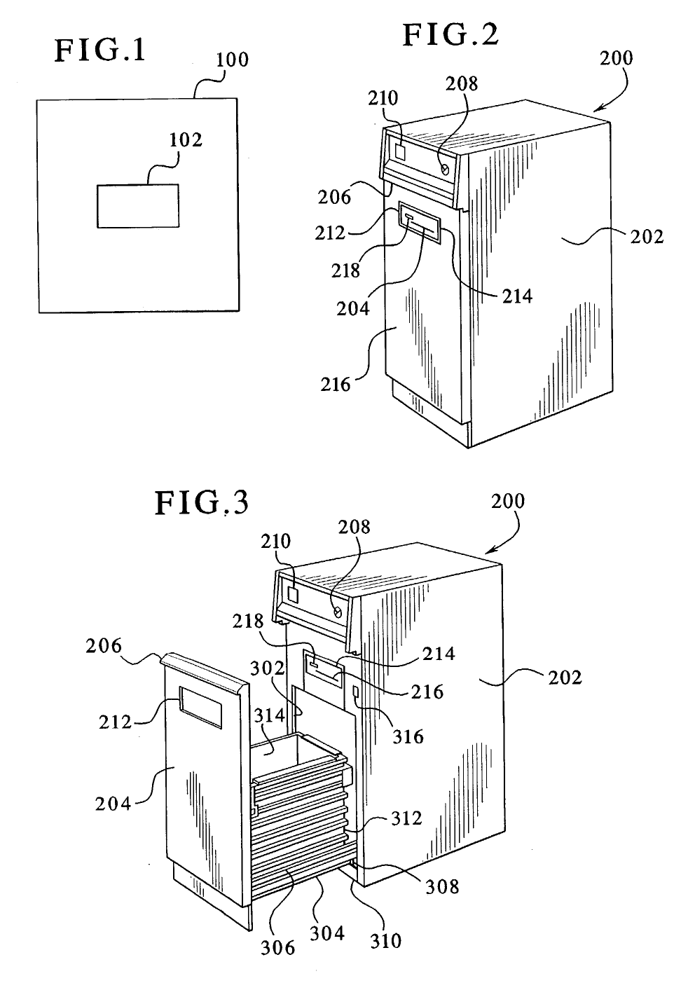

In accordance with apparatuses consistent with the present invention, a trash compactor is provided that has an integrated shredder. The shredder of the trash compactor shreds items and trash compactor compacts them. FIG. 1 depicts a block diagram of a compactor consistent with the present invention. As illustrated in FIG. 1, the compactor 100 has an integrated shredder 102. Each of these items will be described in more detail below with references to the remaining figures.

Referring to FIG. 2, FIG. 2 depicts a perspective view of an illustrative compactor 200 in accordance with the present invention. The compactor 200 is shown to comprise an outer cabinet 202 having a front opening 302 (See FIG. 3) selectively closed by a door 204. The door 204 is depicted on a front face of the compactor 200, however, the present invention is not limited thereto. For example, the door 204 can be on a side face, back face, or a top of the compactor 200. The door 204 has a handle 206 for manipulating the door 204.

The compactor 200 may be operated by a compactor control operator 208, which can be, for example, a switch or a knob. One of skill in the art will appreciate that the compactor control operator 208 is not limited to being a switch or a knob, and can be for example a touch pad or another suitable operator.

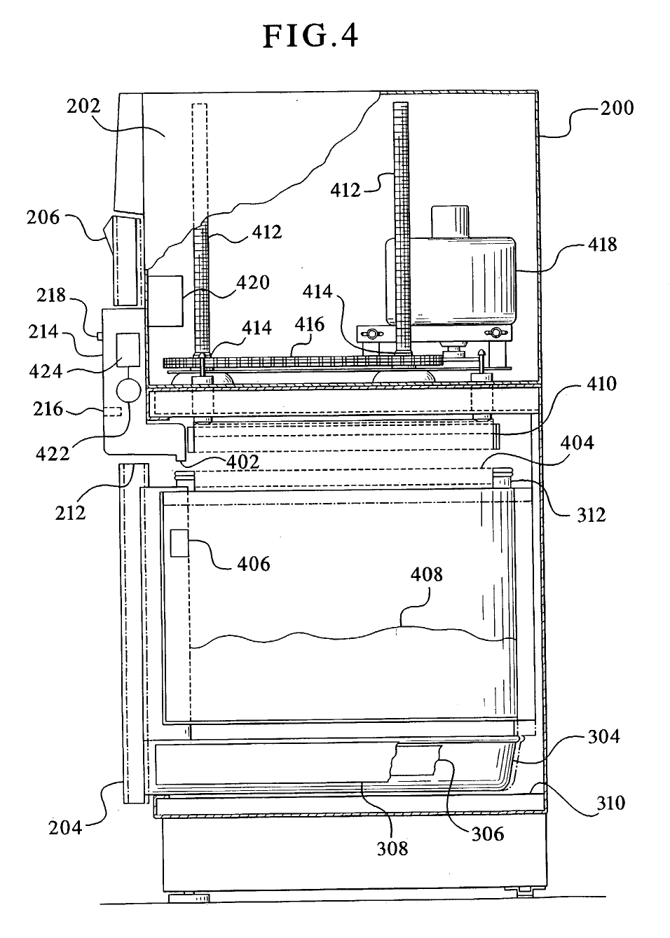

A level indicator 210 indicates a level of the trash 408 (See FIG. 4) within the compactor 200. The level indicator 210 can be any suitable device for indicating level, such as a light, a series of lights, or a numerical display.

The door 204 has an opening 212 through which a shredder 214 is accessible. As will be described in more detail below, the shredder 214 has a receiving opening 216 for receiving items to be shredded. The shredder 214 may be operated by shredder control operator 218, which can be a device similar to the compactor control operator 208.

Referring to FIG. 3, FIG. 3 depicts the compactor 200 of FIG. 2 with the door 204 opened. The door 204 may be supported on a carrier 304 provided with a suitable door roller track 306 associated with a complementary base roller track 308 carried by a base portion 310 of the compactor 200. One of skill in the art will appreciate that the door 204 can alternatively be connected to the compactor 200 by a suitable means other than that which is depicted in FIG. 3. For example, the door 204 can be connected to the base portion 310 or outer cabinet 202 of the compactor 200 via a hinge device. Further, in the illustrative example, the door 204 can be removed from the compactor 200 by moving the carrier 304 to a forwardmost position.

When the door 204 is opened, as depicted in FIG. 3, a receptacle 312 is exposed. Thus, a user can place items that require compaction into the receptacle 312. As will be described in more detail below, trash and shredded items are compacted within the receptacle 312. The receptacle 312 is removable and sets on the carrier 304. Alternatively, the receptacle 312 can set on the base portion 310 of the compactor 200. Still further, the receptacle 312 can be suspended from its top or sides by a suspension device attached to the compactor 200. For example, the receptacle 312 can be suspended by rails attached to the outer cabinet 202. A removable liner 314 can be at least partially located within the receptacle 312 for receiving items to be compacted.

A door sensor 316 senses when the door 204 is in a closed position. The door sensor 316 can be a suitable device for sensing the presence of the door 204. For example, the door sensor 316 can be a mechanical switch, a proximity sensor, or a photo sensor.

Referring to FIG. 4, FIG. 4 depicts a side sectional view of the compactor 200 with the door 204 in a closed position. As illustrated, a discharge opening 402 of the shredder 214 in located at a position higher than a top opening 404 of the receptacle 312. Accordingly, when shredded items are discharged from the shredder 214, the shredded items fall into the top opening 404 of the receptacle 312. Although the discharge opening 402 is illustratively depicted, in FIG. 4, as being located directly over the receptacle 312, the discharge opening 402 is not limited to that configuration. The discharge opening 402 can be at a suitable position that is above or higher than the receptacle 312. This permits the shredded items to fall into the receptacle 312 using gravity. Also, the compactor 200 can comprise a guide (not shown) that guides shredded items from the discharge opening 402 into the receptacle 312.

The shredder 214 comprises at least one shredder blade 422 for shredding items. The shredder blade 422 can have any suitable configuration for shredding an item. For example, the shredder blade 422 can shred the item into strips or, alternatively, can cut the item in both a lengthwise direction and a widthwise direction. The shredder blade 422 is driven by a shredder motor 424.

A level sensor 406 determines the level of the trash 408 within the receptacle 312. And as described above, this level can be displayed on level indicator 210.

A ram 410 extends downwardly to compact the trash 408 toward a bottom of the receptacle 312. As illustrated, the ram 410 is retracted and spaced above the top opening 404 of the receptacle 312. The ram 410 is supported by a ram frame 411. During operation, the ram 410 extends through the top opening 404 of the receptacle to compact the trash 408. The ram 410 is driven vertically by, for example, one or more drive screws or threaded support rods 412 that are coupled to one or more sprockets 426. The sprockets 426 are rotatably driven by a suitable drive 416, such as a chain or belt, powered by an electric motor 418. The drive 416 is coupled to the electric motor 418 by a motor sprocket 428. The drive screws are threaded through cooperating threaded support members or power nuts 414 for support. The power nuts 414 are secured to the ram frame 411. Alternatively, the ram 410 can be hydraulically driven, wherein threaded support rods 412, power nuts 414, and sprockets 426 are replaced by hydraulic pistons. Although one threaded support rod 412, one sprocket 426, and one power nut 414 are depicted in FIG. 4, one of skill in the art will appreciate that the invention is not limited thereto. For example, additional threaded support rods, sprockets, and power nuts can be used on one or more other sides of the ram 410.

Operational control of the compactor 200 is performed by a controller 420, which is electrically coupled to a power source (not shown), the electric motor 418, the level sensor 406, the door switch 316, the shredder control operator 218, the level indicator 210, and the compactor control operator 208.

During operation, the user can place items to be compacted either directly in the receptacle 312 or in the receiving opening 216 of the shredder 214. To place items directly in the receptacle 312, the user opens the door 204, which exposes the receptacle 312. In illustrative embodiment shown in FIG. 3, when the door 204 is opened, the receptacle 312 is at least partially extracted from the compactor 200. This permits the user to easily place items within the receptacle 312.

Alternatively, the user can feed items through the receiving opening 216 of the shredder 214. Neither the shredder 214 nor the ram 410 will operate unless the door 204 is in a closed position. The controller 420 determines whether the door is in the closed position responsive to a signal received from the door sensor 316. Alternatively, operation of the shredder 214 and the ram electric motor 418 can be hardwired through the door switch 316. This reduces the cost of the compactor by eliminating the need for the controller 420. If the controller 420 is not used, then the level sensor 406 and the level indicator 210 will be electrically coupled to each other.

Once the door 204 is closed, the user can activate the shredder 214 by operating the shredder control operator 218. When the shredder control operator 218 is effected to an “ON” state, the shredder 214 turns on. Accordingly, power is applied to the shredder motor 424, which activates and rotates the shredder blade 422. When the user feeds an item into the receiving opening 216, the item is shredded by the shredder blade 422. The shredded item exits the shredder 214 through the discharge opening 402 and falls through the top opening 404 of the receptacle 312.

The user can continue to feed items into the receiving opening 216 of the shredder 214 until the level sensor 406 identifies that the trash 408 in the receptacle 312 has reached a predetermined high level. When the trash 408 reaches the predetermined high level, the level sensor 406 sends an electronic signal to the controller 420. Accordingly, the controller 420 turns off the shredder 214. Alternatively, if the controller 420 is not used, the level sensor 406 will itself turn off the shredder 214 by either creating an open circuit or sending an electronic signal to the shredder 214.

In order to reduce the level of the trash 408 in the receptacle, the user actuates the ram 410 by operating the compactor control operator 208 to an “ON” state. This effectuates turning on the ram electric motor 418, which in turn drives the ram 410 downward into the receptacle 312. When the ram 410 contacts the trash 408 in the receptacle, the ram 410 compacts the trash toward the bottom of the receptacle 312. Alternatively, the ram 410 can be automatically turned on responsive to a signal generated by the level sensor 406.

The user can operate the shredder 214 and the ram 410 simultaneously, however, in the illustrated embodiment, this is prevented since shredded items will fall on top of the ram 410 when the ram 410 is extended into the receptacle 312.

As the ram 410 comes down and compacts the trash 408, when the ram electric motor 418 stalls, it reverses its rotation direction, which changes the direction of the ram 410. The ram 410 then moves upward. A centrifugal switch 424 determines when the ram electric motor 418 stalls, and send a signal to the ram electric motor 418 to change direction. Alternatively, the centrifugal switch 424 can send a signal to the controller 420, which will in turn send a signal to the ram electric motor 418 to change direction. The ram 410 can be retracted before it reaches a lowest possible position.

In accordance with the compactor 200 consistent with the present invention, the compactor 200 has an integral shredder 214 for providing the multiple functions of shredding and compacting by a single device. Therefore, time and waste are reduced over typical shredding machines and compactors, which are typically separate devices.

The present invention has been described utilizing particular embodiments. As will be evident to those skilled in the art, changes and modifications may be made to the disclosed embodiments and yet fall within the scope of the present invention. The disclosed embodiments are provided only to illustrate aspects of the present invention and not in any way to limit the scope and coverage of the invention. The scope of the invention is therefore only to be limited by the appended claims.

What is claimed is:

1. A compactor comprising:
a receptacle having a receptacle opening at a top of the receptacle for receiving refuse;
a shredder having a receiving opening accessible from an outside of the compactor and a discharge opening located at a position higher than the receptacle opening for delivering shredded items into the receptacle; and
a ram for vertically compacting refuse and the shredded items toward a bottom portion of the receptacle.

2. The compactor according to claim 1, further comprising:
a door on an outer part of the compactor for permitting access to the receptacle.

3. The compactor according to claim 2, further comprising:
a sensor for determining when the door is in a closed position, wherein the shredder and the ram do not operate when the door is not in the closed position.

4. The compactor according to claim 2, wherein the door has a door opening therethrough, the receiving opening of the shredder being disposed within the door opening.

5. The compactor according to claim 1, wherein the receptacle is removable.

6. The compactor according to claim 1, further comprising a removable liner, at least a portion of the removable liner being disposed within the receptacle.

7. The compactor according to claim 1, further comprising a level sensing device for determining a level of refuse and shredded items in the receptacle.

8. The compactor according to claim 7, further comprising a level indicator for indicating the level of refuse in the receptacle.

9. The compactor according to claim 2, wherein the door is connected to the compactor via a hinge device.

10. The compactor according to claim 2, wherein the door horizontally slidingly opens from the compactor.

11. The compactor according to claim 10, wherein the receptacle is removeably connected to the door, to receptacle being at least partially located at an outside of the compactor when the door is opened.

12. The compactor according to claim 1, wherein the ram comprises a drive for downwardly extending the ram into the receptacle.

13. The compactor according to claim 12, wherein the drive is a hydraulic drive.

14. The compactor according to claim 12, wherein the drive is an electric drive.

15. The compactor according to claim 1, wherein the shredder shreds the shredded items into strips.

16. The compactor according to claim 1, wherein the shredder shreds items received into the shredder in a lengthwise direction and in a widthwise direction.

17. A compactor comprising:
a receptacle;
a shredder for shredding items and discharging the shredded items into the receptacle;
a ram for vertically compacting the shredded items toward a bottom of the receptacle.
